(19) United States
(12) Patent Application Publication
(10) Pub. No.: US 2016/0115986 A1
(43) Pub. Date: Apr. 28, 2016

(54) SYSTEM FOR RIVETING FROM OPPOSITE SIDES OF A WORKPIECE

(71) Applicant: Ford Global Technologies, LLC, Dearborn, MI (US)

(72) Inventors: Amanda Kay Freis, Ann Arbor, MI (US); Aindrea McKelvey Campbell, Beverly Hills, MI (US)

(21) Appl. No.: 14/520,488

(22) Filed: Oct. 22, 2014

(51) Int. Cl. F16B 19/10; F16B 19/08

(52) U.S. Cl. CPC F16B 19/1036; F16B 19/10; F16B 19/086

(57) ABSTRACT

A system for attaching layers of a material stack-up of at least three layers together using rivets alternatingly place on each side of the stack-up is disclosed. The system includes a material stack-up comprising an upper layer, an intermediate layer and a lower layer, a first rivet attaching the upper layer and the intermediate layer, and a second rivet attaching the lower layer and the intermediate layer. The first rivet attaches the upper layer to the intermediate layer through the upper layer and the second rivet attaches the lower layer to the intermediate layer through the lower layer. The first and second rivets are alternatingly positioned in a spaced apart relationship. The rivets are selected from the group consisting of self-piercing rivets, blind rivets and solid rivets. When self-piercing rivets are used, the first rivet includes rivet tail and the second rivet includes rivet tail.

### TECHNICAL FIELD

The disclosed inventive concept relates generally to the riveting of a workpiece. More particularly, the disclosed inventive concept relates to a system for riveting from opposite sides of a workpiece.

### BACKGROUND OF THE INVENTION

The automobile manufacturing industry is constantly faced with new challenges in a wide array of areas including vehicle safety, reliability, durability and cost. Perhaps the greatest challenge faced by the automobile industry today is the need to improve fuel mileage to both decrease carbon emissions and increase fuel economy for both environmental and cost reasons, all without compromising safety, power or durability. In 2011, new fuel economy requirements were imposed that establish a US vehicle fleet average of 54.5 miles per gallon by 2025. As the industry moves to that target year fuel annual economy requirements will be ramped up for different-sized vehicles.

Efforts have been made to increase fuel economy for vehicles. These efforts can be divided into two approaches: the “supply” side and the “demand” side.

On the supply side attention is drawn to improving energy conversion efficiency through use of, for example, electric or hybrid-electric drive trains. In addition, new vehicle drive trains, including smaller engines and more efficient transmission having multiple gears and transfer cases, are being developed and employed. Other technologies, including start-stop and engine cylinder deactivation strategies, are also proving effective at decreasing fuel consumption. Improved transmissions with multiple gears are also important elements to increased fuel consumption efficiencies.

On the demand side weight reduction is key, though other aspects, such as improved aerodynamics and drag reduction, are also important. Conventional vehicles, particularly trucks, rely on steel components. For over 100 years the material of choice for most vehicles is steel. Today steel makes up about 60% of the average car by weight.

Despite the improvement in steel composition the weight of steel regardless of type remains significant. It is also possible to reduce vehicle weight when steel is used by reducing component thickness. However, at a certain point it is no longer practical to reduce steel thickness regardless of the steel grade used. The use of high strength steel or advanced, high strength steel does not improve the realization that there are limits to how much vehicle weight can be reduced by steel thickness reduction without compromising vehicle performance.

Thus as the automotive industry continues to focus on light weighting vehicles to meet customer expectations on fuel economy and CAFE requirements, interest in alternative materials including aluminum intensive vehicle applications has increased. This is because vehicle weight reduction is most directly accomplished through substituting lighter materials for currently used steel parts. However, a limited variety of materials are available as a substitute for automotive steel. One such material is carbon fiber which is both lightweight and strong.

While carbon fiber offers certain performance advantages, replacement of the steel body-in-white with carbon fiber is expensive and brings with it a relatively slow production process.

Accordingly, much attention is drawn to the use of aluminum which is about ⅓ the weight of steel. Aluminum is not a new material for automotive use and has been used as a material for castings for over 100 years. The use of aluminum not only provides weight reduction but also results in good crash performance. Research has shown that in collisions aluminum can perform as well as conventional steel and demonstrates the ability to absorb twice the crash energy per pound of mild steel, having good buckling and energy absorption characteristics.

In body-in-white structures, joining methods have traditionally relied on resistance-spot welding (e.g., in steel structures). In the case of aluminum intensive vehicles and other mixed metal joining applications, self-piercing rivet (SPR) technology prevails. One advantage of self-piercing rivet technology is that it is a high production volume assembly process. Further, it is compatible with an adhesive, where both methods can be used in conjunction.

The challenge often faced when using the self-piercing rivet to fasten together multiple layers is that the substrate material must have sufficient thickness to enable a satisfactory mechanical interlock between the rivet and the bottom layer while simultaneously avoiding a rivet break-through out of the lower layer. Production downtime due to rivet break-through can be exacerbated for applications which contain adhesive as the glue can contaminate the rivet equipment. Additionally, material stack-ups that are three layers (3T) and greater can be especially challenging to rivet as the bottom layer thickness relative to the total stack is too small to provide adequate interlock.

In cases where riveting a 3T application is not possible due to no interlock, the situation may be remedied occasionally by using a rivet having a greater length. In some instances, however, a solution is not found prior to causing break-through when increasing the length of the rivet. Conversely, when break-through occurs there are applications where using a shorter rivet will result in no interlock, resulting in a joint having no mechanical strength.

As in so many areas of vehicle technology there is always room for improvement related to the mechanical fastening of the materials through self-pierce riveting.

### SUMMARY OF THE INVENTION

The disclosed inventive concept overcomes the problems associated with known systems for riveting a material stack-up of at least three layers. The system includes a material stack-up comprising an upper layer, an intermediate layer and a lower layer, a first rivet attaching the upper layer and the intermediate layer, and a second rivet attaching the lower layer and the intermediate layer. The first rivet attaches the upper layer to the intermediate layer through the upper layer and the second rivet attaches the lower layer to the intermediate layer through the lower layer.

The first and second rivets are alternatingly positioned in a spaced apart relationship. The rivets are selected from the group consisting of self-piercing rivets, blind rivets and solid rivets. When self-piercing rivets are used, the first rivet includes rivet tail and the second rivet includes rivet tail. The rivets are alternatingly positioned such that the tail of the first rivet are adjacent the tail of the second rivet when the layers of material are attached by the rivets.

Optionally, an adhesive may be included between the upper layer and the intermediate layer. Alternatively or additionally, an adhesive may also be included between the intermediate layer and the lower layer.

By alternating rivets according to the disclosed inventive concept, only two layers are joined from each side, thereby avoiding difficulties such as “break-through” of the bottom layer where adhesive is exposed and can contaminate the rivet die and associated equipment and the “no interlock” result between layers where the rivet has not splayed sufficiently to lock the layers together. Accordingly, the disclosed inventive concept enables greater application of rivet joining, particularly self-piercing rivet joining, and more particularly in difficult stacks, such as where thin layers are on the bottom of the sheet metal stack-up.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1A is a schematic illustration of the first step of a self-piercing rivet process according to the prior art in which the blankholder and the punch are in position above the rivet prior to pressure being applied to the punch;

FIG. 1B is a schematic illustration of the second step of the self-piercing rivet process according to the prior art in which initial pressure has been applied to the punch;

FIG. 1C is a schematic illustration of the third step of the self-piercing rivet process according to the prior art in which the rivet has pierced the upper layer and is interlocked into the lower layer;

FIG. 1D is a schematic illustration of the fourth step of the self-piercing rivet process according to the prior art in which the rivet process has been completed and the punch and blankholder have been removed;

FIG. 2A is a cross-section view of a self-piercing rivet joint illustrating a break-through on the lower layer according to the prior art;

FIG. 2B is a plan view of the lower layer where the self-piercing rivet joint has broken through according to the prior art;

FIG. 3A is a cross-section view of a self-piercing rivet joint illustrating a rivet that has not splayed sufficiently to lock layers of sheet-metal together according to the prior art;

FIG. 3B is a cross-section view of a self-piercing rivet joint illustrating a rivet that has splayed sufficiently to lock layers of sheet-metal together according to the prior art; and

FIG. 4 is a cross-section view of a rivet arrangement according to the disclosed inventive concept in which the rivets are inserted in alternating directions.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

The disclosed inventive concept may find use in any number of applications where plural layers of the same or dissimilar materials are being attached. Accordingly, the disclosed inventive concept may be used in the production of automotive vehicles and trucks.

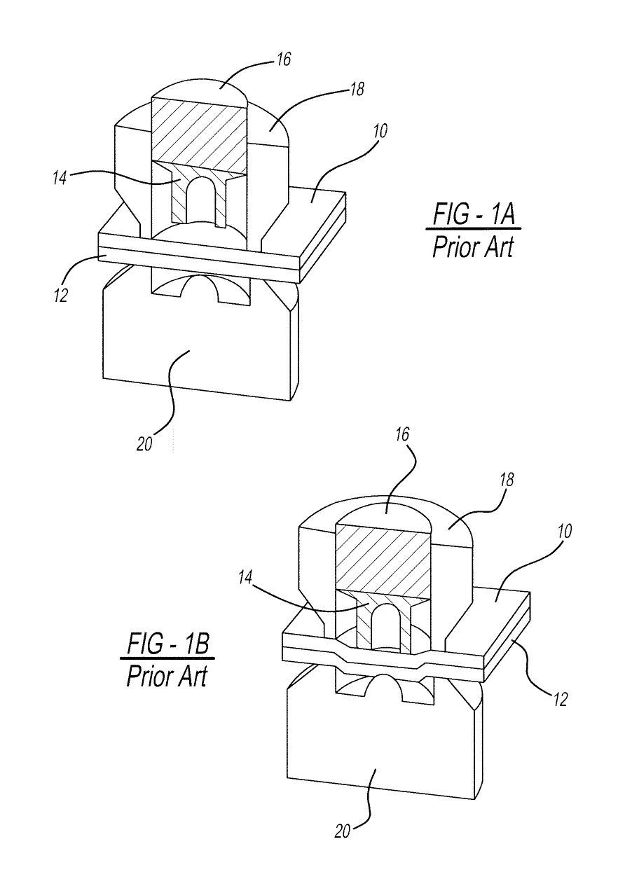

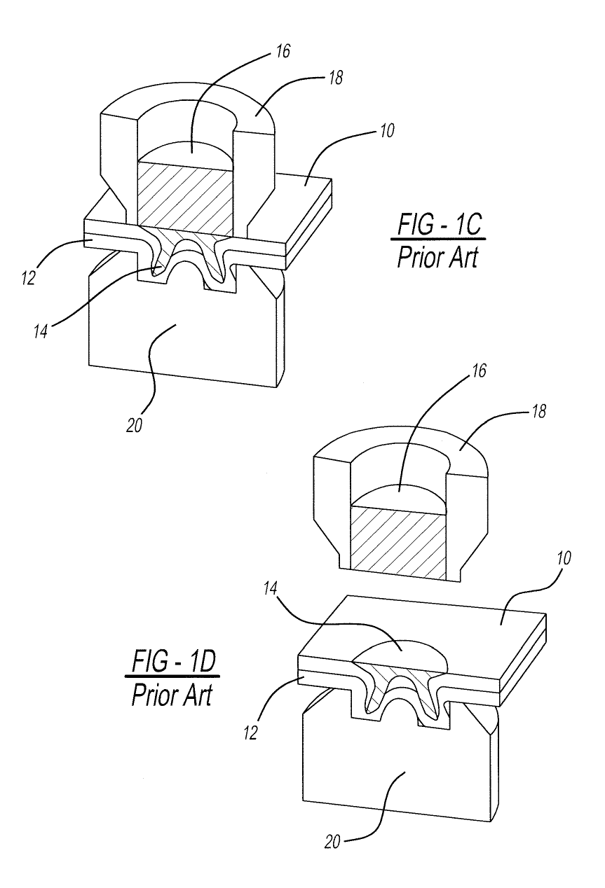

The use of self-piercing rivets in the assembly of plural components is a known technique as illustrated in FIGS. 1A through 1D. These figures schematically show steps involved in the self-piercing rivet process. As the rivet is inserted into the stack. the material deforms into the die and the resultant form is called a “button.”

As illustrated in FIG. 1A, the first step of a self-piercing rivet process according to the prior art is illustrated. A first layer is shown in position over a second layer 12. A rivet 14 is illustrated in position over the first layer 10. A punch 16 and a blankholder 18 are illustrated in position with the rivet 14 prior to pressure being applied to the punch 16. A die 20 is in position beneath the second layer 12.

In FIG. 1B, the second step of the self-piercing rivet process according to the prior art is illustrated. In this step, initial pressure has been applied to the punch 16 and the rivet 14 is shown beginning to deform the first layer 10 and the second layer 12.

In FIG. 1C, the third step of the self-piercing rivet process according to the prior art is illustrated. In this step, the punch 16 has been fully inserted through the blankholder 18 such that the rivet 14 pierced the first layer 10 and forms the second layer 12.

In FIG. 1D, the fourth step of the self-piercing rivet process according to the prior art is illustrated. In this step, the rivet 14 is shown fully inserted through the first layer 10 and a button is formed in the second layer 12. The punch 16 and the blankholder 18 have been moved out of contact with the first layer 10.

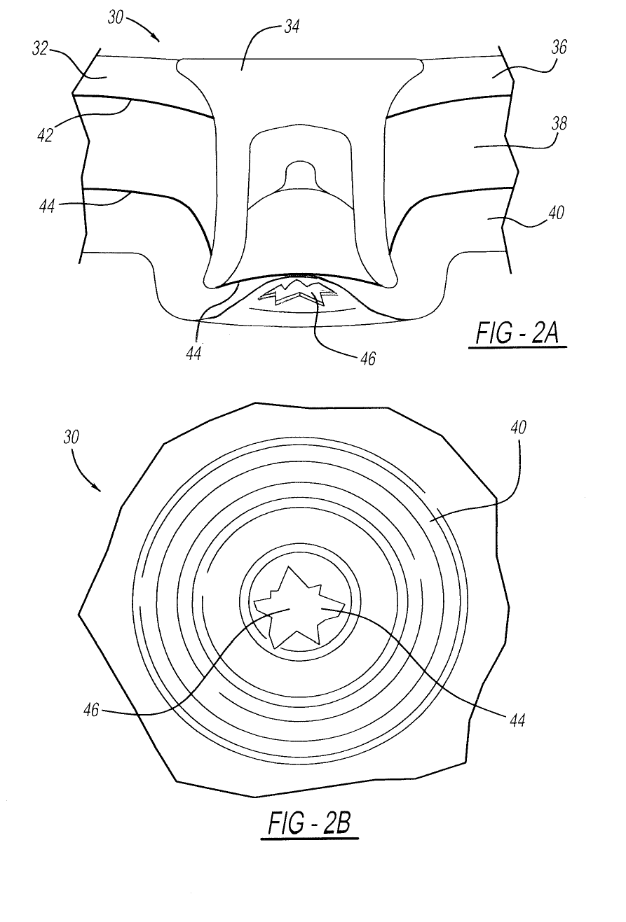

While a valuable mechanical fastener in many automotive and other assembly applications, use of the self-piercing rivet is occasionally challenged by the fact that the substrate material must have sufficient thickness to enable mechanical interlock between the rivet and the bottom layer while simultaneously avoiding a condition known in the industry as “rivet break-through.” This condition is illustrated in FIGS. 2A and 2B.

Referring to FIG. 2A, a cross-section view of a self-piercing rivet joint is shown and is generally illustrated as 30. The self-piercing rivet joint 30 includes a material stack-up 32 and a self-piercing rivet 34. The material stack-up 32 includes a first or upper layer 36, a second or middle layer 38, and a third or lower layer 40. Thus the second or middle layer 38 is sandwiched between the first or upper layer 36 and the third or lower layer 40. An upper adhesive layer 42 is formed between the first or upper layer 36 and the second or middle layer 38. A lower adhesive layer 44 is formed between the second or middle layer 38 and the third or lower layer 40.

When riveted, the rivet joint 30 may experience “break-through” where some of the lower adhesive layer 44 is exposed at a breach 46 formed through the third or lower layer 40. The breach 46 is shown more fully in FIG. 2B which is a plan view of the third or lower layer 40. In the event that the breach 46 is formed, a portion of the adhesive of the lower adhesive layer 44 is exposed and may contaminate the self-piercing rivet die and installation equipment, thus exacerbating production downtime due to rivet break-through in material stack-ups where adhesive is used as glue between layers.

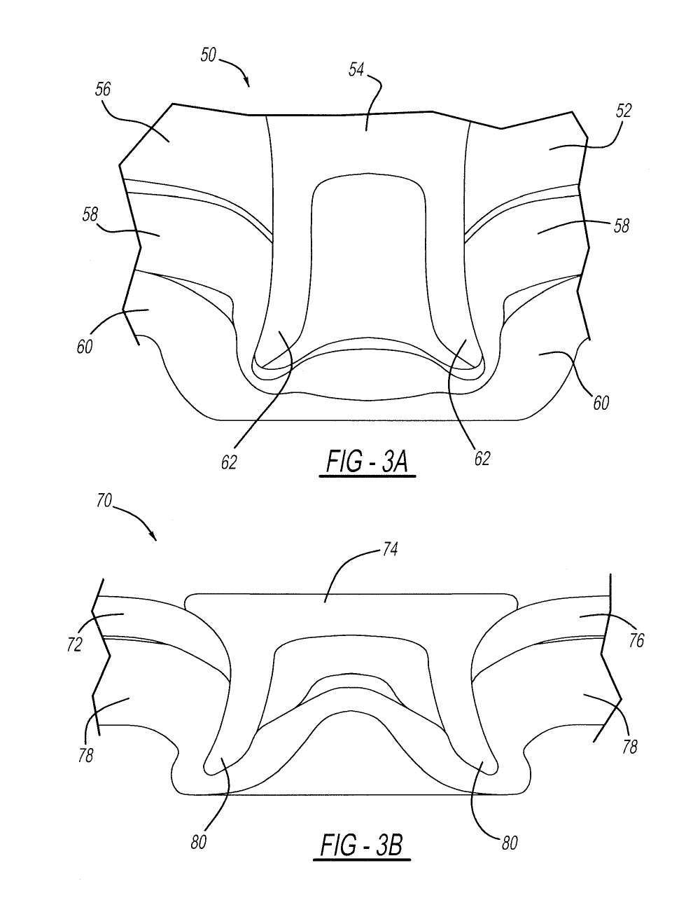

Self-piercing rivets suffer from shortcomings in other applications as well. Referring to FIG. 3A, a cross-section view of a self-piercing rivet joint, generally illustrated as 50, is shown. The self-piercing rivet joint 50 includes a material stack-up 52 and a self-piercing rivet 54. The material stack-up 52 includes a first or upper layer 56, a second or middle layer 58, and a third or lower layer 60. Thus the second or middle layer 58 is sandwiched between the first or upper layer 56 and the third or lower layer 60. The self-piercing rivet 54 includes a pair of spaced-apart and opposed tails 62 and 62′.

When riveted, the rivet joint 50 may suffer from a “no interlock” condition in which tails 62 and 62′ do not splay sufficiently as illustrated. Under such a circumstance, the self-piercing rivet 54 fails to lock together the first or upper layer 56, the second or middle layer 58, and the third or lower layer 60.

The failed results of the rivet joint 50 may be compared with an acceptable interlock illustrated in FIG. 3B in which a cross-section view of a self-piercing rivet joint, generally illustrated as 70, is shown. The self-piercing rivet joint 70 includes a material stack-up 72 and a self-piercing rivet 74. The material stack-up 52 includes a first or upper layer 76 and a second or middle layer 78. The self-piercing rivet 74 includes a pair of spaced-apart and opposed tails 80 and 80. As illustrated, because the material stack-up 72 includes only two layers as opposed to three layers of the material stack-up 52 of FIG. 3A, the self-piercing rivet 74 has less material to pierce and thus the tails 80 and 80′ can more easily splay to their proper position in which an acceptable interlock can be achieved as shown in FIG. 3B. Accordingly, material stack-ups which are three layers (3T) and greater can be especially challenging to rivet as the bottom layer thickness relative to the total stack is too small to provide adequate interlock.

The disclosed inventive concept combines the relative effectiveness of riveting two layers of material with the advantage of using rivets to attach material stack-ups having three or more layers while preventing lower layer “break-through” and consequent adhesive exposure and while also preventing a “no interlock” condition that is often found when three layers of material are riveted using a single rivet.

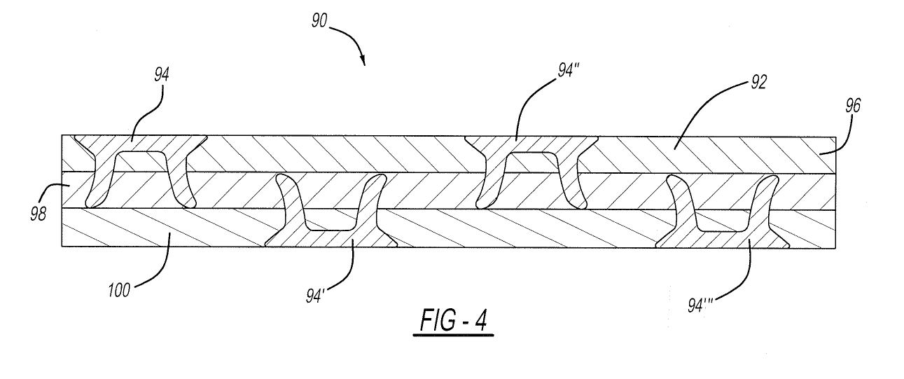

Particularly, and referring to FIG. 4, a cross-section view of a self-piercing rivet joint according to the disclosed inventive concept is shown and is generally illustrated as 90. The self-piercing rivet joint 90 includes a material stack-up 92 and self-piercing rivets 94, 94′, 94″ and 94′″ that are alternatingly positioned on the self-piercing rivet joint 90 such that the self-piercing rivets 94 and 94″ enter the self-piercing rivet joint 90 through one side while the self-piercing rivets 94′ and 94′″ enter the self-piercing rivet joint 90 through the opposite side. Any number of self-piercing rivets may thus be used provided that some degree of alternating directions between one side and the other is employed. Furthermore, while self-piercing rivets are illustrated, it is to be understood that other types of rivets, such as blind rivets and solid rivets, may be employed as well,

The material stack-up 92 includes a first or upper layer 96, a second or middle layer 98, and a third or lower layer 100. Thus the second or middle layer 98 is sandwiched between the first or upper layer 96 and the third layer or lower layer 100. However, it is to be understood that more than three layers of material may be included in the material stack-up. The first or upper layer 96, the second or middle layer 98 and the third or lower layer 10 may be any of a variety of materials including metals such as steel or, more particularly, carbon steel grade (DP800) or carbon-fiber composites. An adhesive may be applied between said first or upper layer 96 and said second or middle layer 98 prior to assembly. In addition or alternatively, an adhesive may be applied between said third or lower layer 100 and said second or middle layer 98 prior to assembly,

Thus arranged, each of rivets 94, 94′, 94″ and 94′″ join only two layers. Specifically, and as illustrated, the self-piercing rivets 94 and 94″ join the first or upper layer 96 and the second or middle layer 98 while the self-piercing rivets 94 and 94′″ join the third or lower layer 100 and the second or middle layer 98. When all of the rivets 94, 94, 94″ and 94′″ are considered in combination, the resulting monolith represented as the self-piercing rivet joint 90 is robustly joined. The disclosed inventive concept may be extended to material stack-ups having more than three layers.

The disclosed inventive concept enables greater application of rivet joining. particularly self-piercing rivet joining, and more particularly in difficult stacks, such as where thin layers are on the bottom of the sheet metal stack-up. The disclosed inventive concept also avoids the weakening of such joints via other solutions such as “scalloping,” or separating the application into two two-layer stack-ups, thus potentially eliminating adhesive applicability, saving both material and labor costs.

For at least the above reasons the disclosed invention as set forth above overcomes the challenges faced by known methods for riveting multiple layers of material by rivets inserted with alternating directions. However, one skilled in the art will readily recognize from such discussion, and from the accompanying drawings and claims that various changes, modifications and variations can be made therein without departing from the true spirit and fair scope of the invention as defined by the following cairns.

What is claimed is:

1. A system for attaching layers of material together comprising:
a material stack-up comprising an upper layer, an intermediate layer and a lower layer;
a first rivet attaching said upper and said intermediate layers;
a second rivet attaching said lower and said intermediate layers, said first rivet attaching said upper layer to said intermediate layer through said upper layer and said second rivet attaching said lower layer to said intermediate layer through said lower layer.

2. The system for attaching layers of material together of claim 1 wherein said first and second rivets are alternatingly positioned in a spaced apart relationship.

3. The system for attaching layers of material together of claim 1 wherein said first rivet includes rivet tail and said second rivet includes rivet tail and wherein said rivets are alternatingly positioned such that said tall of said first rivet are adjacent said tail of said second rivet when said layers of material are attached by said rivets.

4. The system for attaching layers of material together of claim 1 wherein at least one of said first and second rivets is a self-piercing rivet.

5. The system for attaching layers of material together of claim 1 wherein at least one of said first and second rivets is a blind rivet.

6. The system for attaching layers of material together of claim 1 wherein at least one of said first and second rivets is a solid rivet.

7. The system for attaching layers of material together of claim 1 further including adhesive between at least two of said layers.

8. A system for attaching layers of material together comprising:
a material stack-up comprising an upper layer, a lower layer and an intermediate layer between said upper and lower layers;
a first rivet attaching said upper layer and said intermediate layer; and
a second rivet attaching said lower layer and said intermediate layer.

9. The system for attaching layers of material together of claim 8 wherein said upper layer is on a first side of said stack-up and said lower layer is on a second side of said stack-up, said first rivet attaching said upper layer to said intermediate layer through said first side and said second rivet attaching said lower layer to said intermediate layer through said second side.

10. The system for attaching layers of material together of claim 9 wherein said first and second rivets are alternatingly positioned in a spaced apart relationship.

11. The system for attaching layers of material together of claim 9 wherein said first rivet includes a rivet tail and said second rivet includes a rivet tail and wherein said rivets are alternatingly positioned such that said tail of said first rivet are adjacent said tail of said second rivet when said layers of material are attached by said rivets.

12. The system for attaching layers of material together of claim 9 wherein said first and second rivets are selected from the group consisting of self-piercing rivets, blind rivets and solid rivets.

13. The system for attaching layers of material together of claim 9 wherein at least one of said first and second rivets is a self-piercing rivet.

14. The system for attaching layers of material together of claim 9 wherein at least one of said first and second rivets is a blind rivet.

15. The system for attaching layers of material together of claim 9 wherein at least one of said first and second rivets is a solid rivet.

16. The system for attaching layers of material together of claim 8 further including adhesive between at least two of said layers.

17. A system for attaching layers of material together comprising:
a material stack-up comprising a first layer having an outer side and a second layer having an outer side;
an intermediate layer between said first and second layers:
a first rivet inserted through said first layer and into said intermediate layer:
a second rivet inserted through said second layer and into said intermediate layer, said first and second rivets being alternatingly positioned.

18. The system for attaching layers of material together according to claim 17 wherein said first rivet includes a rivet tail and said second rivet includes a rivet tail and wherein said rivets are alternatingly positioned such that said tail of said first rivet are adjacent said tail of said second rivet when said layers of material are attached by said rivets.

19. The system for attaching layers of material together of claim 17 wherein said first and second rivets are selected from the group consisting of self-piercing rivets, blind rivets and solid rivets.

20. The system for attaching layers of material together of claim 17 further including adhesive between at least two of said layers.
